(19) United States
(12) Patent Application Publication
(10) Pub. No.: US 2026/0078581 A1
(43) Pub. Date: Mar. 19, 2026

(54) HIGH-DENSITY REINFORCED CEMENT PANEL INCLUDING SOUND DAMPING LAYER AND SYSTEMS USING SAME AND METHODS FOR MAKING SAME

(71) Applicant: UNITED STATES GYPSUM COMPANY, CHICAGO, IL (US)

(72) Inventor: Frank Charles POSPISIL, Oak Park, IL (US)

(73) Assignee: UNITED STATES GYPSUM COMPANY, CHICAGO, IL (US)

(21) Appl. No.: 19/180,586

(22) Filed: Apr. 16, 2025

Related U.S. Application Data
(60) Provisional application No. 63/696,583, filed on Sep. 19, 2024.

(51) Int. Cl. E04C 2/288; B32B 7/06; B32B 7/12; B32B 13/12; G10K 11/00

(52) U.S. Cl. CPC E04C 2/288; B32B 7/12; B32B 13/12; G10K 11/002; B32B 7/06; B32B 2250/02; B32B 2250/03; B32B 2307/102; B32B 2607/00

(57) ABSTRACT

A method for assembling a wall system to retrofit an existing panel and frame building assembly for a wall, floor or roof, including providing a sound damping building panel including a dense, fiber-reinforced, structural cementitious panel of fiber-reinforced cement, the dense, fiber-reinforced, structural cementitious panel having a first surface opposed to a second surface, and a layer of acoustic dampening material on the first surface of the dense, fiber-reinforced, structural cementitious panel; attaching the sound damping panel to an existing building panel attached to an existing frame for a wall, floor or roof, the existing building panel having an interior surface facing the frame and an exterior surface opposed to the interior surface. This locates the layer of acoustic dampening material between the exterior surface of the building panel and the first surface of the sound damping panel. A sound damping building panel is also provided.

### FIELD OF THE INVENTION

The present invention is generally related to retrofitting wall systems used in both interior and exterior construction, and more particularly to retrofitting such wall systems designed for improving the acoustic characteristics of structures. For the purposes of the present discussion, “wall systems” will be understood to refer to floor, roof and ceiling construction as well as walls.

### BACKGROUND OF THE INVENTION

Reducing the amount of noise to which the average person is exposed is emerging as both an economic and public policy issue. Soundproof or sound-reduced (collectively referred to as soundproofing below) rooms or buildings are desired for a variety of purposes. For example, apartments, hotels and schools all often desire rooms with walls, ceilings and floors that significantly reduce the transmission of generated sound to avoid annoying people in adjacent rooms.

Soundproofing is particularly important in buildings adjacent to public transportation, such as highways, airports and railroad lines, as well as in theaters, home theaters, music practice rooms, recording studios and others. As wallboards differ in their compositions, so does their ability to provide an acoustical barrier. One measure of the severity of the problem is the widespread emergence of city building ordinances that specify a minimum Sound Transmission Class (“STC”) rating.

Accordingly, wallboards are classified based to their ability to diminish (dampen) sound transmission through a wall. This wallboard characteristic is known as Sound Transmission Class (STC) which can be measured for each wallboard according to ASTM standard method E90 “Standard Test Method Laboratory Measurement of Airborne Sound Transmission Loss of Building Partitions and Elements.” The single number rating scheme STC is derived from the measured Sound Transmission Loss from 125 to 4000 Hz one-third octave bands.

Sound rated walls and floors are typically evaluated by American Society for Testing and Materials (ASTM) Standards E90 for Sound Transmission Class (STC) ratings and E492 with respect to Impact Insulation Class (IIC). The greater the IIC rating, the less impact noise and the less airborne sound will be transmitted to the area below. The International Building Code (IBC) specifies that floor/ceiling installations between units on multi-family buildings must have an IIC rating of not less than 50 and an STC rating of not less than 50. Even though an IIC rating of 50 meets many building codes, experience has shown that in luxury condominium applications, floor-ceiling systems having an IIC of less than 55 may not be acceptable because some impact noise is still audible and considered annoying at those levels.

The STC single number rating is calculated according to ASTM E413 “Classification for Sound Insulation” for a particular wallboard structure by fitting the reference contour defined in E413 to the measured Transmission Loss (TL) or Normalized Attenuation (Dn, c) data until the sum of deficiencies of the data compared to the reference value does not exceed 32 dB and the maximum deficiency at any one frequency does not exceed 8 dB. The single number rating is given by the value of the shifted reference contour at 500 Hz.

The higher is the STC value of a particular wallboard, the better this wallboard is at absorbing noise. Building construction codes may require wallboard with a certain minimum STC value for each particular application.

Conventional interior walls are made using wood or metal studs with drywall panels on both exterior surfaces of the studs, and baffles of insulation or plates commonly placed between the studs in an attempt to reduce the transmission of sound from one room to the next. Unfortunately, these relatively simple walls have achieved limited success in reducing sound transmission. The excessive sound transmission through such walls has led to apartment tenant complaints, and in some cases, litigation.

Various construction techniques and products have emerged to address the problem of noise control, such as: replacement of wooden framing studs with light gauge steel studs; alternative framing techniques such as staggered-stud and double-stud construction; additional gypsum drywall panel layers; the addition of resilient channels to offset and isolate drywall panels from framing studs; the addition of mass-loaded vinyl barriers; cellulose-based sound board; and the use of cellulose and fiberglass batt insulation in walls not requiring thermal control. All of these changes contribute to reducing the noise transmission, but not to such an extent that certain disturbing noises (e.g., those with significant low frequency content or high sound pressure levels) in a given room are prevented from being transmitted to a room designed for privacy or comfort. The noise may come from rooms above or below the occupied space, or from an outdoor noise source. In fact, several of the above-named techniques only offer a three to six decibel improvement in acoustical performance over that of standard construction techniques, with no regard to acoustical isolation. Such a small improvement represents a just noticeable difference, not a soundproofing solution.

A second concern with the above-named techniques is that each involves the burden of either additional (sometimes costly) construction materials or extra labor expense due to complicated designs and additional assembly steps.

An alternative building noise control product has been introduced to the market in the form of a laminated damped drywall panel as disclosed in U.S. Pat. No. 7,181,891. That panel, known as a constrained panel, and including a central layer of acoustic dampening material or adhesive sandwiched between conventional wallboard panels, replaces a traditional drywall layer and eliminates the need for additional materials such as resilient channels, mass loaded vinyl barriers, additional stud framing, and additional layers of drywall. The resulting system offers excellent acoustical performance improvements of up to 15 decibels in some cases. However, such systems are susceptible to water damage, and as such are unsuitable for exterior construction, or for use in floors or roofs.

Sound rated or floating floor systems are known for acoustically isolating a room beneath a floor on which impacts may occur, such as pedestrian footfalls, sports activities, dropping of toys, or scraping caused by moving furniture. Impact noise generation can generally be reduced by using thick carpeting, but where vinyl, linoleum, tile, hardwood, wood laminates and other types of hard surfaces including decorated concrete finishes are to be used, a sound rated floor is desirable and required by codes for acoustical separation of multifamily units. The transmission of impact noise to the area below can be reduced by resiliently supporting or acoustically decoupling and/or dampening the underlayment floor away from the floor substructure.

The entire floor system contributes to transmitting the noise into the area below. If the floor surface receiving the impact is isolated from the substructure, then the impact sound transmission will be greatly reduced. A dampening material can also reduce transmitted noise. Likewise, if the ceiling below is isolated from the substructure, the impact sound will be restricted from traveling into the area below.

Sound mats are known for use in flooring systems. A suitable mat is disclosed in U.S. Pat. No. 10,370,860 which is incorporated by reference.

US Published patent application no. 2022/0251828 to Pospisil et al. discloses a method for assembling a wall system to an existing frame for a wall, floor or roof, including: attaching a first dense, fiber-reinforced cement panel to the frame, the panel having an interior surface facing the frame, and an exterior surface; applying a layer of acoustic dampening material to the exterior surface; and attaching a second dense, fiber-reinforced cement panel to at least one of the dampening material, the first panel, and the frame. It also discloses a building panel including, a first panel of dense, fiber-reinforced cement; an internal layer of acoustic dampening material; and a second panel of dense, fiber-reinforced cement such that the dampening material is sandwiched between the first and second cement panels. This shows a construct that was manufactured by assembling the components on site.

In a preferred embodiment, the system of US 2022/0251828 is assembled onsite, using the following steps: to an existing frame for a wall, floor or roof, a first dense, fiber-reinforced cement panel is attached, the panel having an interior surface facing the frame, and an exterior surface; a layer of acoustic dampening material is applied to the exterior surface; a second dense, fiber-reinforced cement panel is attached to at least one of the dampening material, the first panel, and the frame.

In another embodiment, in US 2022/0251828 a building panel is provided, including a first panel of dense, fiber-reinforced cement, an internal layer of acoustic dampening material; and a second panel of dense, fiber-reinforced cement such that the dampening material is sandwiched between the first and second cement panels.

In still another embodiment in US 2022/0251828, in a manufacturing facility away from the final building site, a modular structure is constructed using the above-described panels of a dampening material sandwiched between dense, fiber-reinforced cement panels, then the module is shipped to the site where the final building is being erected by stacking and connecting the individual modules. The constrained system in US 2022/0251828 is either preassembled as the modular unit or in pieces to be built/assembled onto the modules.

US Pat. App. Pub. No. 2016/0230395 to Cusa et al. [0006] discloses a method of constructing a sound damping wallboard on a building structure that comprises fastening a first wallboard to the building structure, providing a second wallboard that is a sound damping wallboard of its invention, and fastening the second wallboard to the first wallboard with the sound damping layer disposed between the gypsum layer of the second wallboard and the first wallboard. US '395 discloses that the sound damping wallboard includes a gypsum layer and a sound damping layer between first and second encasing layers. The gypsum layer includes a gypsum layer inner surface and a gypsum layer outer surface. The sound damping layer is disposed at the gypsum layer inner surface. The first encasing layer is disposed at the gypsum layer outer surface and the second encasing layer is disposed at a sound damping layer inner surface opposite the gypsum layer inner surface. A third encasing layer is between the gypsum layer and the sound damping layer. An encasing layer is disposed on each of the gypsum layer inner surface and the gypsum layer outer surface, thereby forming the first encasing layer and the third encasing layer. US '395 [0018] discloses the second encasing layer or the third encasing layer may be constructed of or include a carrier sheet, such as a “peel & stick” layer, where the carrier sheet may be removed during the wallboard manufacturing or installation process. In an embodiment, the second encasing layer is constructed of a carrier sheet that is removable prior to installation.

Other features of the physical characteristics of construction panels are their structural capacities; their flexural and shear strength. Flexural strength refers to the panel's ability to resist breaking when a force is applied to the center of a simply supported panel. Values of flexural strength are given in pounds of force (lbf) or Newtons (N). The measurement technique used to establish the flexural strength of gypsum wallboard or similar construction panels is ASTM C 473-06a “Standard Test Methods for the Physical Testing of Gypsum Panel Products” (publication date Nov. 1, 2006). For floors and roofs the standard that can be used is ASTM E330 (2014) “Standard Test Method for Structural Performance of Exterior Windows, Doors, Skylights and Curtain Walls by Uniform Static Air Pressure Difference.” To measure shear capacities in walls ASTM E72 (2015) “Standard Test Methods of Conducting Strength Tests of Panels for Building Construction” or ASTM E2126 (2019) “Standard Test Methods for Cyclic (reversed) Load Test for Shear Resistance of Vertical Elements of the Lateral Force Resisting Systems for Buildings” can be used. To establish floor and roof diaphragm capacities, ASTM E455 (2019) “Standard Test Method for Static Load Testing of Framed Floor or Roof Diaphragm Construction for Buildings” or the AISI TS-7 (2002) “Cantilever Test Method for Cold-Formed Steel Diaphragm” are typically used. These standards are available on the Internet, and it is understood in the art that such standards change over time, but such changes are acknowledged by those skilled in the art. Conventional constrained building panels have been found to have limited flexural and shear strengths.

There is a need for a sound damping building panel that is structured for retrofit installation and attachment to a wallboard or other panel of wall material previously installed onto the frame of a wall to improve the acoustical performance of the wall. Thus, it will be seen that there is a need for easier to install wall systems that reduce the transmission of noise when retrofitting existing structures.

There is also a need for easier to install wall systems that focus on the reduction of transmission of low frequency sound when retrofitting existing structures.

### SUMMARY OF THE INVENTION

The above-listed needs are met or exceeded by the present constrained panel wall system that is designed for either load-bearing or non-load-bearing construction applications of walls, ceilings, roofs and floors. An acoustic dampening material is applied to a dense reinforced fiber cement panels to form a sound dampening board that can be delivered to an installation site to retrofit an existing wall.

Due to the enhanced strength of the resulting system, either load-bearing floor, roof or walls are potential construction applications. Thus, the present system is optionally configured as a load-bearing floor, or a load-bearing or non-load-bearing wall system. Additionally, the present wall system is suitable in non-load-bearing system.

In method aspects the present invention provides a method of making a wall system is a high-STC and IIC floor or wall system including a constrained damping layer sandwiched between reinforced cement panels each having a density of 55 pcf (881 kg/m³) or greater, Typically 55 pcf (881 kg/m³)-100 pcf (1602 kg/m³). As a result, the present system attains high airborne and impact sound ratings. The present wall system is usable in any construction where a high-acoustic performance is required, especially where low-frequency noise reduction is a priority.

The method includes the steps of:
providing a sound damping building panel (also known as a sound dampening panel) comprising a first dense, fiber-reinforced, structural cementitious panel of fiber-reinforced cement having a density of 55 pcf (881 kg/m³) or greater, the first dense, fiber-reinforced, structural cementitious panel having a first surface opposed to a second surface, and a layer of acoustic dampening material (also known as acoustic dampening compound, acoustic damping material, or acoustic damping compound) preferably viscoelastic acoustic dampening material, on the first surface of the dense, fiber-reinforced, structural cementitious panel;
attaching the sound damping building panel to an existing building panel attached to an existing frame for a wall, floor or roof, the existing building panel having an interior surface facing the frame and an exterior surface opposed to the interior surface,
wherein the sound damping panel is attached to the existing building panel to locate the layer of acoustic dampening material between the exterior surface of the building panel and the first surface of the sound damping building panel.

Typically the layer of acoustic dampening material contacts the exterior surface of the building panel. However, if the sound damping building panel has a cover sheet over the layer of acoustic dampening material, and the cover sheet is not removed from the sound damping building panel, then the layer of acoustic dampening material contacts the cover sheet of the sound damping panel. Typically the layer of acoustic dampening material contacts the first surface of the sound damping building panel.

The invention also provides a sound damping building panel comprising:
a single sheet of reinforced cement having a density of 55 pcf (881 kg/m³) or greater as a dense, fiber-reinforced, structural cementitious panel, the dense, fiber-reinforced, structural cementitious panel having opposed first and second outer surfaces;
a layer of acoustic dampening material (also known as acoustic dampening compound, sound dampening material or sound dampening compound), preferably viscoelastic acoustic dampening material, on the opposed first outer surface; and
a cover sheet, wherein the acoustic dampening material is located between the single sheet of reinforced cement and the cover sheet;
wherein the cover sheet has first and second sides, the cover sheet first side in contact with the layer of acoustic dampening material to contact and cover at least 80% of the area of the layer of acoustic dampening material.

The sound damping building panel is pre-manufactured in advance of being sent to the installation site for the retrofitting of an existing building panel and frame system. The sound damping building panel is pre-manufactured to include the dense, fiber-reinforced, structural cementitious panel of a dense fiber reinforced cement and the layer of acoustic dampening material. The invention retrofits an existing structure to have better acoustic damping properties by attaching this pre-manufactured sound damping building panel to an existing panel already attached to an existing frame. This is easier than retrofitting an existing structure by applying the layer of acoustic dampening material to the existing panel, and then applying a dense, fiber-reinforced, structural cementitious panel over the layer of acoustic dampening material at the retrofitting installation site.

In an embodiment, the acoustic dampening material is an adhesive, and attaching the sound damping building panel includes inserting at least one fastener into at least one of the existing panel and the frame. Then once the acoustic dampening material has set, removing the at least one fastener and patching at least one hole created by the fastener. In an embodiment, applying the acoustic dampening material to the dense, fiber-reinforced, structural cementitious panel is accomplished through rolling, brushing, spraying or troweling. In another option, some of the fasteners are retained and not removed for retaining the face panel in position.

Optionally, the acoustic dampening material is provided in sheet form and attached to the dense, fiber-reinforced, structural cementitious panel at the facility for manufacturing the sound damping building panel.

Optionally, the acoustic dampening compound may be provided as a rolled up package of the polymer layer with release paper that is unrolled on the dense, fiber-reinforced, structural cementitious panel at the facility for manufacturing the sound damping building panel.

Preferably the acoustic dampening material is tacky to adhere to the sound damping panel. Preferably the acoustic dampening material is tacky to adhere to the existing building panel when contacted with the existing building panel. Preferably the acoustic dampening material is viscoelastic. Preferably the acoustic dampening material is viscoelastic so that it is tacky. Preferably the acoustic dampening material remains viscoelastic so that it remains tacky.

In an embodiment, the acoustic dampening material is an adhesive including alkyl abietate, a plant resin and polyvinyl alcohol. In another embodiment, the acoustic dampening material is an adhesive applied in a layer of 0.02 inch to 0.10 inch and including a polymer having a glass transition temperature (T_{g}) of −10° C. to about 30° C. It is contemplated that the adhesive further includes plasticizer. In still another embodiment, each of the first and second dense, fiber-reinforced cement panels have a density of 55 pcf (881 kg/m³) or greater.

The cover sheet that covers the acoustic dampening material is typically a cover sheet which is a polymer or paper cover sheet. The cover sheet may be permanently or releasably attached to the dense, fiber-reinforced, structural cementitious panel. The acoustic dampening material may be a polymer, such as carpenter glue (wood glue), alone or mixed with inert filler such as gypsum powder. The chemistry of wood glue typically involves the use of Polyvinyl Acetate (PVA) as the main ingredient, which undergoes cross-linking and polymerization processes when applied to wood surfaces.

The sound damping building panel would be applied (screwed) to a base wall surface to boost the Sound Transmission Class (STC) value of the base wall. The base wall surface is new or existing building panel, typically gypsum panel, wood sheathing, block wall, structural shear wall panel, cementitious panel, etc. The acoustic dampening material between both panels would enhance the STC values as compared to simply adding another layer of drywall or cement board, alone. The system creates a constrained layer dampening system (CLD).

### BRIEF DESCRIPTION OF THE DRAWINGS

FIG. 1 is a cross-section of a pre-manufactured sound damping wall board (sound dampening building panel) provided with two cover sheets.

FIG. 2 is a cross-section of a pre-manufactured sound damping wall board provided with one cover sheet.

FIG. 3 is a fragmentary view of a wall created using the present method, with portions removed for clarity.

FIG. 4 is a fragmentary view of a wall created using the present method, with portions removed for clarity, but including a sound damping panel that includes one cover sheet when applied to an existing building panel of an existing wall system.

FIG. 5 schematically shows the structure of a tested panel and wall assembly of Comparative Example 1.

FIG. 6 schematically shows the structure of a tested panel and wall assembly of Example 2.

FIG. 7 schematically shows the structure of a tested panel and wall assembly of Comparative Example 3.

FIG. 8 schematically shows the structure of the tested panel and wall assembly of Comparative Example 4.

FIG. 9 schematically shows the structure of the tested panel and wall assembly of Comparative Example 5.

### DETAILED DESCRIPTION

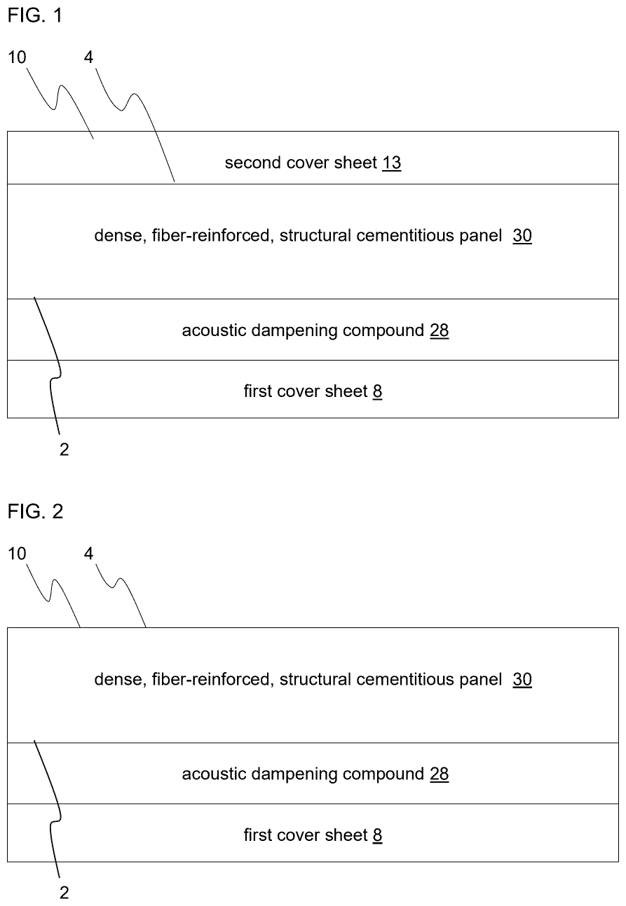

Referring now to FIG. 1, shows a sound damping building panel 10 comprising a dense, fiber-reinforced, structural cementitious panel 30 of fiber-reinforced cement having a density of 55 pcf (881 kg/m³) or greater, the dense, fiber-reinforced, structural cementitious panel 30 having a first surface 2 opposed to a second surface 4, and a layer 28 of acoustic dampening material (also known as a layer 28 of sound damping material) on the first surface 2 of the dense, fiber-reinforced, structural cementitious panel 30. The panel 10 typically has a density of at least 80 pcf (1281 kg/m³), for example 80-100 pcf. The sound damping panel 10 locates the layer 28 of acoustic dampening material, on the first surface 2 of the dense, fiber-reinforced, structural cementitious panel 30, between the dense, fiber-reinforced, structural cementitious panel 30 and the first cover sheet 8 to contact the dense, fiber-reinforced, structural cementitious panel 30 and contact the first cover sheet 8. The first cover sheet 8 may permanently or releasably adhere to the layer 28 of acoustic dampening material. Preferably layer 28 of acoustic dampening material is a layer 28 of viscoelastic acoustic dampening material.

A second cover sheet 13 is optionally present and adhering to the second surface 4 of the dense, fiber-reinforced, structural cementitious panel 30. The first and second cover sheets 8, 13 may be made of the same or different materials.

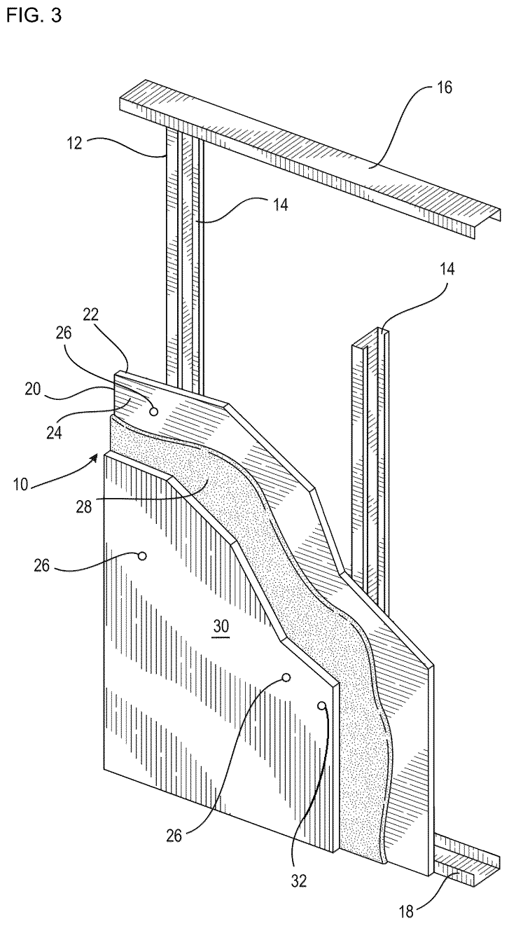

The acoustic dampening material 28 applied to the exterior first surface 2 of the dense, fiber-reinforced, structural cementitious panel 30 is contemplated as having a wide range of compositions, but being resilient and absorbing sound waves. The acoustic dampening material 28 is optionally provided as an adhesive-like composition or as a sheet of material, and is also referred to as the adhesive 28 as a coating or a layer. When the former is utilized, the acoustic dampening material 28 is applied to the exterior first surface 2 using a roller, a brush, a trowel, or is sprayed upon the dense, fiber-reinforced, structural cementitious panel 30 using conventional spraying equipment. When provided as a sheet of material, the acoustic dampening material 28 is secured to the dense, fiber-reinforced, structural cementitious panel 30 using fasteners 26 (FIG. 3) or adhesive. In a preferred embodiment, the acoustic dampening material 28 is applied in a thickness of 0.02 inch to 0.10 inch.

FIG. 2 is a cross-section of a pre-manufactured sound damping wall board 10 provided with only the first cover sheet 8.

FIG. 3 is a fragmentary view of a wall created using the present method, with portions removed for clarity.

FIG. 3 shows an existing wall system comprising the panel 20 attached to the frame 12 and the sound damping panel 10 attached to the panel 20 of the existing wall system. The frame 12 includes regularly spaced vertical studs 14 held in place by headers 16 and footers 18 using threaded fasteners or the like as are well known in the art. Also as is well known in the art, the frame 12 is made of wood or metal components. Further, the vertical studs 14 are commonly placed at a 16-inch (40.6 cm) spacing measured from their center, but may be spaced closer or as far apart as 24-inches (61.0 cm). For the purposes of the present disclosure, because the same panel is usable in floor, wall, ceiling and roof systems, “wall” will be understood to refer to all such uses.

The panel 20 of the existing wall system has an interior surface 22 facing the frame 12, and an exterior surface 24. As is known in the art, the panel 20 of the existing wall system is secured to the frame 12 using fasteners 26. The panel 20 may be any conventional building panel. However, it is preferred that the panel 20 has a density of at least 55 pounds per cubic foot (pcf) (881 kg/m³). It is further preferred that the panel 20 has a density of at least 80 pcf (1281 kg/m³), for example 80-100 pcf.

FIG. 3 shows the sound damping panel 10 with the first cover sheet 8 removed prior to adhering the layer 28 of acoustic dampening material to an external surface of the panel 20.

FIG. 3 shows the sound damping panel 10 with the optional second cover sheet not present.

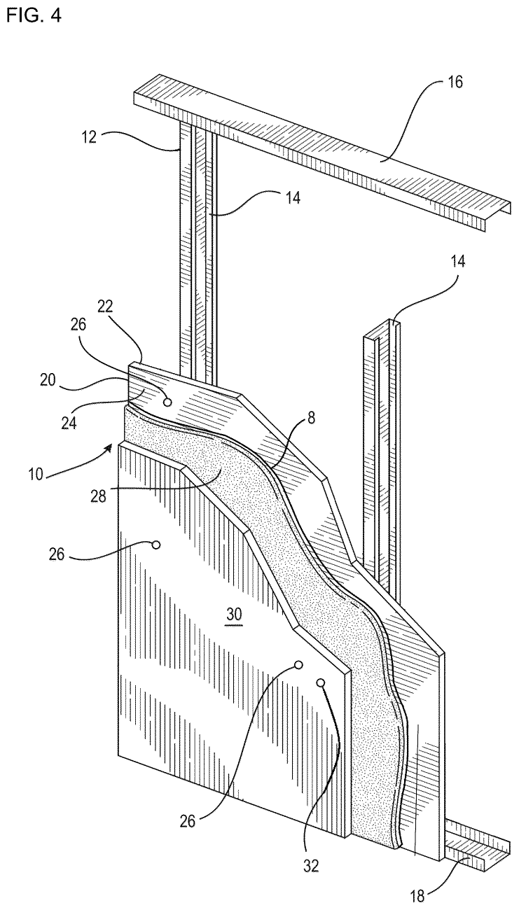

FIG. 4 is a fragmentary view of a wall created using the present method, with portions removed for clarity, but including a sound damping panel 10 applied to include the first cover sheet 8 when applied to an existing building panel 22 of an existing wall system. Thus, rather than remove the first cover sheet 8 prior to applying the sound damping panel 10 to the existing panel 20, the first cover sheet 8 remains on the dense, fiber-reinforced, structural cementitious panel 30. As a result, the first cover sheet 8 is located between the existing panel 20 and the acoustic dampening material 28 when the sound damping panel 10 is applied to an existing building panel 20 of an existing wall system. FIG. 4 shows the sound damping panel 10 with the optional second cover sheet not present.

It is contemplated that the sound damping panel 10 is made by pre-assembling at a manufacturing facility. These sound damping panels 10 are then transported to an installation site (also known as a job site or a construction site). At the installation site is the existing wall system comprising the wall panels 20 attached to the frame 12.

At the installation site the sound damping panels 10 are attached to the exterior surface 24 of a panel 20 of the existing wall system to form a final sound damping system. The sound damping panel 10 is applied to the surface 24 of the existing panel 20 so that dampening material 28 is located between the existing panel 20 and the dense, fiber-reinforced, structural cementitious panel 30. In a preferred embodiment, the dense, fiber-reinforced, structural cementitious panel 30 is attached to at least one of the first panel 20 and the frame 12 by fasteners 26.

It is also contemplated that the manufacturing facility for manufacturing the sound damping panel 10 can be on the installation site or at a remote assembly location. Such modular construction is described in commonly-assigned U.S. Pat. No. 10,066,390 which is incorporated by reference.

Applying the sound damping panels 10 including dense fiber reinforced cement panels 30 provided with the less-dense acoustic dampening material 28 over an existing wall system retrofits the existing wall system to have greatly improved resistive acoustic properties. Using the high density panel 30 with the lower density constrained (sandwiched) material 28, wherein the existing wall panel 20 is also a dense fiber reinforced cement panel, provides a wall system that is also able to support applied floor and wall loads.

In applications where the acoustic dampening material 28 is a settable adhesive, attaching the dense, fiber-reinforced cement panel 30 includes inserting at least one fastener 32 into the first dense, fiber-reinforced cement panel 20, the acoustic dampening material 28, and the second dense, fiber-reinforced cement panel 30, and optionally the frame 12. Then, once the acoustic dampening material 28 has set, the at least one fastener 32 may remain or may be removed and the resulting holes are patched as known in the art.

### The Dense, Fiber-Reinforced, Structural Cementitious Panel

Included as the dense, fiber-reinforced, structural cementitious panel 30 of the sound damping panel 10 is a first dense, fiber-reinforced, structural cementitious panel 30 as described in U.S. Pat. Nos. 6,986,812; 7,445,738; 7,670,520; 7,789,645; and 8,030,377, which are all incorporated herein by reference. It is also contemplated that the term “fiber-reinforced, structural cementitious panel” also refers to Portland cement-based, Magnesium Oxide cement-based and polymer cement-based panels.

A typical composition for fiber-reinforced, structural cementitious panel 30 includes:
a continuous phase resulting from the curing of a self-leveling aqueous cementitious mixture, having an absence of silica flour, of:
25-45 weight % inorganic cement binder,
35-65 weight % sand filler having a particle size of about 150-450 microns,
5-15 weight % pozzolanic filler having a median particle size of less than or equal to 50 microns,
0.25-5.0 weight % polycarboxylate based self-levelling agent,
6-12 weight % water, and
0.5-6.0% by volume of the total aqueous cementitious mixture of reinforcing fibers.

The inorganic cement binder typically includes at least one of Portland cement based, Magnesium Oxide cement based and polymer cement based panels. The silica flour is ground silica sand typically having a weight median particle size less than 45 microns. The reinforcing fibers are typically selected from glass fibers, metal fibers, polymer fibers and mixtures thereof. The glass fibers are typically about 0.5 to 1.5 inches in length.

### Cover Sheets

The first cover sheet 8 and second cover sheet 13 (if present) may be made of paper or polymer. The first cover sheet 8 and second cover sheet 13 may be made of the same or different materials, first cover sheet 8 and second cover sheet 13 may be permanently or releasably attached to the dense, fiber-reinforced, structural cementitious panel 30 of the sound damping panel 10.

In one or more embodiments, the first cover sheet 8 may be a carrier sheet, such as a releasable “peel & stick” layer, where the carrier sheet may be removed during the wallboard manufacturing or installation process. For example, waxed paper could be used as a releasable carrier sheet.

In an alternative embodiment, the first cover sheet 8 may comprise a coating that is applied to the sound damping layer 28. The coating may be applied by various means known in the art, such as spraying or brushing. In a typical embodiment, the coating is curable composition that is applied to the sound damping layer 28 and then cured to form the first cover sheet 8. Suitable coatings include curable polymer compositions, such as acrylic polymer and copolymer compositions. In a typical embodiment, the coating includes thermal or photo (e.g., UV) curing agents to facilitate curing of the first cover sheet 8.

### Acoustic Damping Compositions/Adhesive Compositions

The acoustic dampening material is contemplated as having a wide range of compositions, but being resilient and absorbing sound waves. The dampening material is optionally provided as an adhesive-like composition or as a sheet of material, and is also referred to as the adhesive as a coating or a layer.

In applications where the acoustic dampening layer 28 is an adhesive, the adhesive layer includes a polymer such as a binder. A suitable adhesive 28 is disclosed in commonly-assigned published US Patent Application US 2019/0338516 which is incorporated by reference. The adhesive layer preferably has a balance between tackiness and relaxation time. That is, the adhesive should be pliable and tacky enough to adhere to both the panels 20 and 30. Concurrently, sound dampening is improved with a high viscoelastic relaxation time. That is, the velocity of sound depends on the elastic modulus of the adhesive (Ě (ω)). Ě (ω) can be expressed as Ě (ω)=E′(ω)+iE″(ω), where E′(ω) is the storage modulus and E″(ω) is the loss modulus of the adhesive and each can be expressed as EQ. 1 and EQ. 2, where w is frequency (for STC ω ranges from 100-5000 Hz) and Θ. is the viscoelastic relaxation time of the adhesive.

$${E}^{′} ( ω ) = \frac{E}{1 + {( ωθ )}^{2}} \qquad EQ . 1$$

$${E}^{″} ( ω ) = E * \frac{ω θ}{1 + {( ωθ )}^{2}} \qquad EQ . 2$$

Accordingly,

$$\frac{{E}^{″} ( ω )}{{E}^{′} ( ω )} = ω θ .$$

Theretore, tor a high θ, the loss modulus is higher as compared to the storage modulus. So, when E″(ω) is greater than E′(ω), the acoustic attenuation in transmission increases. In addition, the adhesive preferably should maintain high viscoelastic relaxation time over time and a range of temperatures.

In a preferred embodiment, the polymer of the adhesive layer 28 is synthetic latex (i.e., an aqueous dispersion of polymer particles prepared by emulsion polymerization of one or more monomers). The latex is a film-forming polymer. The adhesive coating used to form the adhesive layer comprises an aqueous emulsion or dispersion comprising water, surfactant, and latex polymer selected from the group consisting of acrylics, styrene acrylics, acrylic esters, vinyl acrylics, vinyl chloride acrylic, styrene acetate acrylics, butyl acrylics, ethyl acrylics, ethylene polyvinyl acetate, polyvinyl acetate, styrene butadiene, and combinations thereof. If desired, the adhesive coating can have an absence of one or more of the foregoing polymers. Typical acrylics are polymers made from polymers of acrylic acid or acrylates, for example, polyacrylate, poly butyl acrylate, poly ethyl acrylate.

Preferably the latex polymer is selected from styrene-butadiene latex, styrene acrylic polymer, or acrylic ester polymer. Preferably, the latex polymer glass transition temperature is in the range from about −10° C. to about 30° C., more preferably from about 5° C. to about 30° C., more preferably from about-10° C. to about 20° C., and more preferably from about 10° C. to about 20° C.

Typically, the adhesive compositions 28 have at least 10 wt. %, more typically at least 20 wt. % latex polymer. For example, typically 15 to 70 wt. %, 45 to 70 wt. % or 45 to 60 wt. % latex polymer.

The adhesive compositions 28 may also include a plasticizer.

Typically, the adhesive compositions 28 have 0 to 50 wt. % more typically 5 to 50 wt. %, furthermore typically 10 to 30 wt. % plasticizer. However, the adhesive compositions of the invention may have an absence of plasticizer.

Typical plasticizers may be any of abietates, phthalates, terephthalates, benzoates, and epoxidized oils such as epoxidized soybean oil (ESO), preferably the abietates.

The plasticizer improves both tack and sound attenuation. The term “tack” refers to the ability of a material to stick to the surface on momentary contact and then to resist separation.

Typical abietates are alkyl abietate, e.g., methyl abietate or ethyl abietate, or aralkyl abietate, for example benzyl abietate. The abietate is believed to work like a plasticizer and can be used to adjust the softness and tackiness of the adhesive.

The alkyl portion of the alkyl abietate can be a saturated linear or branched C₁ to C₁₆, preferably C₁ to C₈, alkyl group. The aralkyl group is typically benzyl.

Typical abietate plasticizers for use in the present invention are shown in Formula (I).

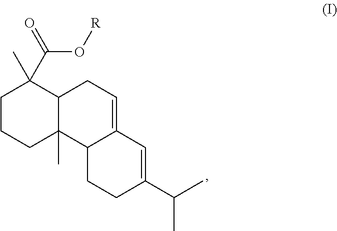

wherein R is a saturated linear or branched C₁ to C₁₈, typically C₁ to C₁₆ or C₁ to C₈ or C₁ to C₄, alkyl group or an aralkyl group, preferably benzyl.

A representative of the alkyl abietate family, methyl abietate, is shown in Formula (II).

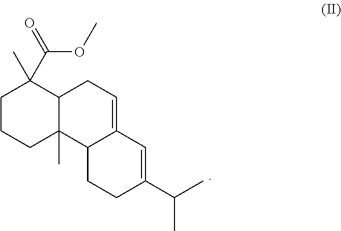 [SMILES: COC(=O)C1(C)CCCC2(C)C3CCC(C(C)C)=CC3=CCC12]

Another representative of the alkyl abietate family, hexadecyl ester of abietic acid (i.e., cetyl abietate), is shown in Formula (III).

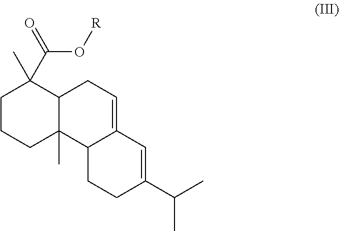

wherein R is a linear alkyl group having the formula C₁₆H₃₃.

The adhesive compositions 28 also optionally include a resin. Typical resins may be any one or more synthetic resins. Typical resins may include any one or more plant resins. For example, typically one or more plant resins such as wood or gum rosin, ester gum, hydrogenated rosin, dammar gum, manila gum, coumarone-indene resin, copal, kauri gum, ethyl cellulose, mastic, and/or sandarac.

Typically, the adhesive compositions 28 have 0 to 25 wt. %, more typically 5 to 20 wt. % resin. However, the adhesive 28 is also contemplated as having an absence of resin.

The adhesive compositions 28 also optionally include a polyvinyl alcohol.

Typically, the adhesive compositions 28 have 0 to 20 wt. %, more typically 5 to 15 wt. % polyvinyl alcohol. However, the adhesive compositions 28 optionally have an absence of polyvinyl alcohol.

A preferred adhesive composition 28 for achieving a balance of properties comprises the above-described polymer and a plasticizer, preferably an alkyl or aralkyl abietate plasticizer.

A more preferred adhesive composition 28 includes a mixture of acrylic polymer, resin, polyvinyl alcohol and alkyl abietate. The acrylic component, resin, and polyvinyl alcohol can provide tack. Further, the hydrogel nature of polyvinyl alcohol also allows it to retain some water in it, which helps with workability and reduction sound transmission of the adhesive.

To improve the workability, different inorganic components (e.g., calcium carbonate, anhydrous gypsum, etc.) can be also included.

If desired particles of sound compliant material and particles of sound-stiff material can also be included in the polymer adhesive layer 28. Such a polymer adhesive layer 28 includes the polymer adhesive as binder and a combination of first particles (the particles of sound compliant material) which are mostly compliant with respect to sound transmission and second particles (the particles of sound-stiff material) which are mostly stiff with respect to sound transmission.

It will be appreciated that the term “compliant material” is used interchangeably with the term “sound-compliant material” and it is understood broadly in this disclosure to mean a material which is at least partially flexible and able to transfer, dissipate and/or absorb sound waves through its body at least partially. It will be further appreciated that the term “stiff material” is used interchangeably with the term “sound-stiff material” and is understood broadly in this disclosure to mean any material which is likely to reflect most of energy from sound waves rather than transfer, dissipate and/or absorb the sound waves.

If desired, the sound-compliant particles are larger in size than sound-stiff particles such that each sound-compliant particle is surrounded with several sound-stiff particles. In other embodiments, sound-compliant particles and sound-stiff particles are of about same size. If desired, the sound-compliant particles and sound-stiff particles are used in the equal molar ratios. However, if desired the sound-compliant particles are the main component and sound-stiff particles are used in only much smaller amounts. In other embodiments, this ratio is reversed. For example, the molar ratio of sound-compliant particles to sound-stiff particles in the compliant coating may be from 1:1 to 1:1,000 or the molar ratio of sound-compliant particles to sound-stiff particles is 1,000:1 to 1:1.

If desired, the polymer adhesive layer 28 includes sound-compliant rubber particles, such as for example tire scrap particles, with sound-stiff nanometric silica particles. It will be further appreciated that any sound-compliant particles are optionally used, including, but not limited to, nitrile rubber, butyl rubber, ethylene propylene diene monomer (EPDM), natural rubber compounds, cotton fibers, organic fibers, inorganic fibers, polypropylene fibers, air-filled glass beads, polystyrene beads or polystyrene foam.

It will be also appreciated that any sound-stiff particles are usable in the compliant coating 28. Such sound-stiff particles may include, but are not limited to, silica particles, clay particles, calcium carbonate, perlite, gas-filled microspheres, hollow microspheres, cenospheres and inorganic glues. If desired, a combination of several sound-compliant materials can be mixed together with at least one sound-stiff material. If desired, a combination of several sound-stiff materials can be mixed together with at least one sound-compliant material. If desired, a combination of several sound-stiff materials can be mixed together with several sound-compliant materials.

However, without being limited by theory, sound has a higher transmission velocity through solid particulates. Therefore, to create the sharp discontinuity in velocity of sound at the different layers, the adhesive layer 28 preferably does not include solid particulates. Generally, the polymer adhesive layer 28 has an absence of mineral filler. Generally, the polymer adhesive layer 28 has an absence of gypsum. Generally, the polymer adhesive coating 28 applied has an absence of gypsum. Generally, the polymer adhesive coating 28 applied has an absence of calcium carbonate. Generally, the polymer adhesive coating 28 applied has an absence of magnesium carbonate. Generally, the polymer adhesive coating 28 applied has an absence of pigment. Generally, the polymer adhesive coating 28 applied has an absence of polyurea. Generally, the polymer adhesive coating 28 applied has an absence of inorganic particles. Generally, the polymer adhesive coating 28 applied has an absence of organic particles.

Generally, the polymer adhesive coating 28 applied has an absence of hydroxyethyl cellulose.

Generally, the adhesive layer 28 is applied in an amount equal to that to form a polymer coating having a thickness of about 0.02 inches (0.051 cm) to about 0.06 inches (0.152 cm), a thickness of about 0.02 inches (0.051 cm) to about 0.05 inches (0.127 cm).

In one embodiment, the adhesive layer 28 is applied by at least one method selected from the group consisting of spray coating, dip coating, rill application, free jet application, blade metering, rod metering, metered film press coating, air knife coating, curtain coating, flexography printing, and roll coating.

Methods for preparing synthetic latexes are well known in the art and any of these procedures can be used. Latexes typically have 1-55 wt. % binder (polymer) and water. Latex is an emulsion with emulsified polymer particles that can vary from 30 nm to 1500 nm. Therefore, the adhesive coating can comprise the emulsified polymer particles with an absence of other particles including solid particles, for example filler particles. Once the adhesive coating is applied and is the adhesive layer in the final inventive product, the latex forms a film (e.g., a continuous film) and is not in particulate form. Therefore, the adhesive layer can have an absence of particulates.

### EXAMPLES

In the following tests, all frames for walls of the following tests are steel studs at 24″ on center with glass fiber insulation. The dense, fiber-reinforced, structural cementitious structural panels used in the examples comprise a first dense, fiber-reinforced, structural cementitious panel of fiber-reinforced cement having a density of 55 pcf (881 kg/m³) or greater.

The STC test results presented below were obtained via laboratory testing conducted according to the ASTM E90 Standard Test Method of Airborne Sound Transmission Loss of Building Partitions and Elements. Further, the STC values were calculated from measured sound transmission losses according to ASTM E413 Classification for Rating Sound Insulation. Elements which are common to each of the experimental embodiments of the system 10 are labeled with the same reference numerals. It is understood that variations of the described experimental embodiments are within the scope of the present disclosure.

### 1. Comparative Example 1

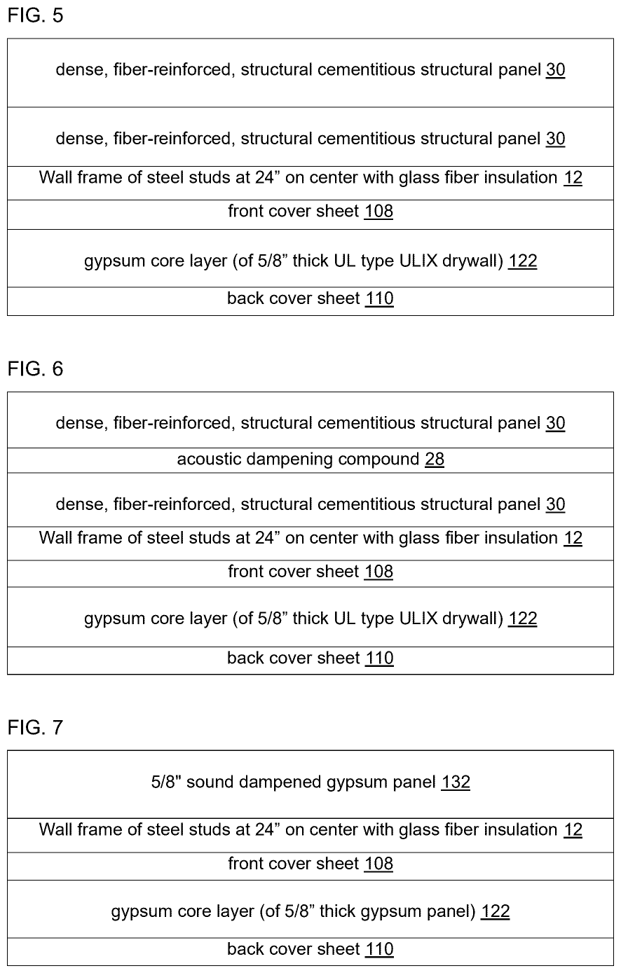

This example tests a panel and wall assembly with two (2) layers of ½″ dense, fiber-reinforced, structural cementitious panel of fiber-reinforced cement having a density of 55 pcf (881 kg/m³) or greater on one side and a single layer of drywall on the other. FIG. 5 schematically shows the structure of the tested panel and wall assembly. The panel and wall assembly of FIG. 5 had two dense, fiber-reinforced, structural cementitious structural panels 30, wall frame 12 of steel studs at 24″ on center with glass fiber insulation, and a ⅝″ thick Underwriters Laboratories (“UL”) type ULIX drywall panel having a front cover sheet 108, a nominally ⅝″ thick gypsum core layer 122, and a back cover sheet 110 attached to the wall frame 12. The tested panel and wall assembly had an STC value of 50 (21 deficiencies, dB below shifted STC Contour).

### 2. Example 2

This example tests a panel and wall assembly that is the same as the panel wall assembly of Comparative Example 1 except that the dampening compound is now between the two layers of ½″ dense, fiber-reinforced, structural cementitious panel having a density of 55 pcf (881 kg/m³) or greater. FIG. 6 schematically shows the structure of the tested panel and wall assembly. The panel and wall assembly of FIG. 6 had a first dense, fiber-reinforced, structural cementitious structural panel 30, acoustic dampening compound 28, a second dense, fiber-reinforced, structural cementitious structural panel 30, a wall frame 12 of steel studs at 24″ on center with glass fiber insulation, a ⅝″ thick Underwriters Laboratories (“UL”) type ULIX drywall panel having a front cover sheet 108, a nominally ⅝″ thick gypsum core layer 122, and back cover sheet 110. This represents an existing wall of a wall frame 12 with a dense, fiber-reinforced, structural cementitious structural panel 30 on one side and a UL type ULIX drywall panel on the other side as the existing building panels, wherein an additional sound damping panel 30 was attached to the dense, fiber-reinforced, structural cementitious structural panel 30 that was an existing building panel, to locate a layer of acoustic dampening material 28 between the exterior surface of the dense, fiber-reinforced, structural cementitious structural panel 30 that was an existing building panel and the first surface of the added sound damping panel 30. The tested panel and wall assembly had an STC value of 53 (30 deficiencies, dB below shifted STC Contour). This is an improvement over the tested panel and wall assembly of Comparative Example 1.

The dense, fiber-reinforced, structural cementitious structural panel blocks the mid- and low-frequencies with a 1 inch overall thickness. The acoustic dampening compound blocks the high frequencies.

### 3. Comparative Example 3

This example tests a panel and wall assembly similar in structure to Comparative Example 1 but, for the two layers of ½″ dense, fiber-reinforced, structural cementitious panel on one side of the frame this example substituted ⅝″ sound dampened gypsum panel 132. There is ⅝″ thick conventional gypsum panel having a gypsum core 122 between front 108 and back 110 cover sheets on the other side of the frame. The ⅝″ sound dampened gypsum panel has a core of naturally occurring gypsum and proprietary additives laminated with a sound damping proprietary viscoelastic polymer glue with paper that is 100% recycled paper on front, back and long edges. FIG. 7 schematically shows the structure of the tested panel and wall assembly. The panel and wall assembly of FIG. 7 had the ⅝″ thick sound dampened gypsum panel 132, the wall frame 12 of steel studs at 24″ on center with glass fiber insulation, and a ⅝″ thick conventional gypsum panel that was an Underwriters Laboratories (“UL”) type SCX gypsum drywall panel having a front cover sheet 108, a nominally ⅝″ thick gypsum core layer 122, and a back cover sheet 110. UL type SCX drywall panel is a slightly heavier drywall panel than UL type ULIX drywall panel. The tested panel and wall assembly had an STC 50 (29 deficiencies, dB below shifted STC Contour). The ⅝″ sound dampened gypsum panel did not take out mid- and low-frequencies as did dense, fiber-reinforced, structural cementitious structural panel.

### 4. Comparative Example 4—Standard Wall With Drywall Panels

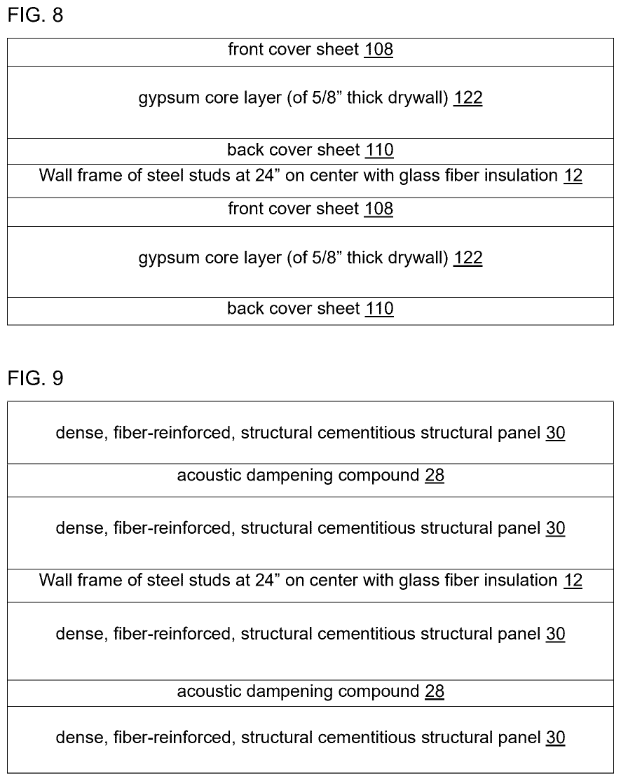

This example tests a panel and wall assembly which was a standard wall with conventional gypsum panel on both sides. The conventional gypsum panel having a gypsum core between front and back cover sheets on the other side of the frame. FIG. 8 schematically shows the structure of the tested panel and wall assembly. The panel and wall assembly of FIG. 8 has a first ⅝″ thick Underwriters Laboratories (“UL”) type ULIX gypsum drywall panel having a front cover sheet 108, a gypsum core layer 122, and a back cover sheet 110, a wall frame of steel studs at 24″ on center with glass fiber insulation 12, and a second Underwriters Laboratories (“UL”) type ULIX ⅝″ thick gypsum drywall panel having a front cover sheet 108, a nominally ⅝″ thick gypsum core layer 122, and a back cover sheet 110. This received an STC of 45 (21 deficiencies, dB below shifted STC contour).

### 5. Example 5—Double Layers of ½″ Dense, Fiber-Reinforced, Structural Cementitious Panel

This example employed double layers of ½″ dense, fiber-reinforced, structural cementitious panel of fiber-reinforced cement having a density of 55 pcf (881 kg/m³) on either side with dampening compound (adhesive) between the layers on each side. FIG. 9 schematically shows the structure of the tested panel and wall assembly. The panel and wall assembly of FIG. 9 had a first dense, fiber-reinforced, structural cementitious structural panel 30, acoustic dampening compound 28, a second dense, fiber-reinforced, structural cementitious structural panel 30, a wall frame 12 of steel studs at 24″ on center with glass fiber insulation, a third dense, fiber-reinforced, structural cementitious structural panel 30, acoustic dampening compound 28, a fourth dense, fiber-reinforced, structural cementitious structural panel 30. This represents an existing wall of the wall frame 12 with the second and third dense, fiber-reinforced, structural cementitious structural panels 30 as the existing building panels, wherein the first and fourth sound damping panels 30 were respectively attached to the first and third existing building panels to locate a layer of acoustic dampening material 28 between the exterior surface of each existing building panel 30 and the first surface of each added sound damping panel 30. This received an STC of 60 (24 deficiencies, dB below shifted STC contour).

### Clauses of the Invention

Clause A1. A method for assembling a wall system to an existing frame for a wall, floor or roof, comprises:
providing a sound damping building panel (also known as a sound dampening panel) comprising a first dense, fiber-reinforced, structural cementitious panel of fiber-reinforced cement having a density of 55 pcf (881 kg/m³) or greater, the first dense, fiber-reinforced, structural cementitious panel having a first surface opposed to a second surface, and a layer of acoustic dampening material (also known as acoustic dampening compound, acoustic damping material, or acoustic damping compound) preferably viscoelastic acoustic dampening material, on the first surface of the dense, fiber-reinforced, structural cementitious panel;
attaching the sound damping panel to an existing building panel attached to an existing frame for a wall, floor or roof, the existing building panel having an interior surface facing the frame and an exterior surface opposed to the interior surface,
wherein the sound damping panel is attached to the existing building panel to locate the layer of acoustic dampening material between the exterior surface of the building panel and the first surface of the sound damping panel.
Clause B2. The method of clause A1, wherein the existing building panel is a second dense, fiber-reinforced cement panel.
Clause C3. The method of clause A1, wherein the existing building panel is a gypsum panel having a gypsum core layer between front and back cover sheets.
Clause D4. The method of clause A1, B2 or C3, wherein the acoustic dampening material is an adhesive, and attaching the first dense, fiber-reinforced cement panel includes inserting at least one fastener into the first dense, fiber-reinforced cement panel and the layer of acoustic dampening material, and then into at least one of the existing building panel and the frame, then once the acoustic dampening material has set, removing the at least one fastener and patching at least one hole created by the fastener.
Clause E5. The method of any of clauses A1 to D4, wherein the acoustic dampening material was provided in sheet form.
Clause F6. The method of any of clauses A1 to D4, wherein the acoustic dampening material was applied to the dense, fiber-reinforced, structural cementitious panel of fiber-reinforced cement of the sound damping building panel through rolling, brushing, spraying or troweling.
Clause G7. The method of any of clauses A1 to F6, wherein the acoustic dampening material is an adhesive including at least one of alkyl abietate, a plant resin and polyvinyl alcohol.
Clause H8. The method of any of clauses A1 to G7, wherein the acoustic dampening material is an adhesive applied in a layer of 0.02 inch to 0.10 inch and including a polymer having a glass transition temperature (T_{g}) of −10° C. to about 30° C.
Clause 19. The method of clause H8, wherein the adhesive further includes plasticizer.
Clause J10. The method of any of clauses A1 to 19, wherein the dense, fiber-reinforced, structural cementitious panel of fiber-reinforced cement of the sound damping building panel has a density of 55 pcf (1281 kg/m³) or greater.
Clause K11. The method of any of clauses A1 to 19, wherein the dense, fiber-reinforced, structural cementitious panel of fiber-reinforced cement of the sound damping building panel has a density of 55-100 pcf (1281-1602 kg/m³) or greater.
Clause L12. The method of any of clauses A1 to K11, wherein existing panel is a second dense, fiber-reinforced, structural cementitious panel of fiber-reinforced cement of the sound damping building panel having a density of 55 pcf (1281 kg/m³) or greater.
Clause M13. The method of any of clauses A1 to K11, wherein existing panel is a second dense, fiber-reinforced, structural cementitious panel of fiber-reinforced cement of the sound damping building panel having a density of 55-100 pcf (1281-1602 kg/m³).
Clause N14. A sound damping building panel, comprising:
a single sheet of reinforced cement having a density of 55 pcf (881 kg/m³) or greater as a dense, fiber-reinforced, structural cementitious panel, the dense, fiber-reinforced, structural cementitious panel having opposed first and second outer surfaces;
a layer of acoustic dampening material (also known as acoustic dampening compound), preferably viscoelastic acoustic dampening material, on the opposed first outer surface; and
a cover sheet, wherein the dampening material is located between the single sheet of reinforced cement and the cover sheet;
wherein the cover sheet has first and second sides, the cover sheet first side in contact with the layer of acoustic dampening material to contact and cover at least 80% of the area of the layer of acoustic dampening material.
Clause O15. The sound damping building panel of clause N14, wherein the fiber reinforced cement panel includes one of Portland cement based, Magnesium Oxide cement based and polymer cement based panels.
Clause P16. The sound damping building panel of clause N14 or O15, wherein the cover sheet is releasable from the dampening material.

While a particular embodiment of the present constrained layer floor and wall damping systems using pre-manufactured sound damping building panel comprising, a high-density reinforced cement panel and a layer of acoustic dampening compound, has been described herein, it will be appreciated by those skilled in the art that changes and modifications may be made thereto without departing from the invention in its broader aspects and as set forth in the following claims.

1. A method for assembling a wall system to an existing frame for a wall, floor or roof, comprises:
providing a sound damping building panel (also known as a sound dampening panel) comprising a first dense, fiber-reinforced, structural cementitious panel of fiber-reinforced cement having a density of 55 pcf (881 kg/m³) or greater, the first dense, fiber-reinforced, structural cementitious panel having a first surface opposed to a second surface, and a layer of acoustic dampening material, preferably viscoelastic acoustic dampening material, on the first surface of the dense, fiber-reinforced, structural cementitious panel;
attaching the sound damping panel to an existing building panel attached to an existing frame for a wall, floor or roof, the existing building panel having an interior surface facing the frame and an exterior surface opposed to the interior surface,
wherein the sound damping panel is attached to the existing building panel to locate the layer of acoustic dampening material between the exterior surface of the building panel and the first surface of the sound damping panel.

2. The method of claim 1, wherein the existing building panel is a second dense, fiber-reinforced cement panel.

3. The method of claim 1, wherein the existing building panel is a gypsum panel having a gypsum core layer between front and back cover sheets.

4. The method of claim 1, wherein the acoustic dampening material is an adhesive, and attaching the first dense, fiber-reinforced cement panel includes inserting at least one fastener into the first dense, fiber-reinforced cement panel and the layer of acoustic dampening material, and then into at least one of the existing building panel and the frame, then once the acoustic dampening material has set, removing the at least one fastener and patching at least one hole created by the fastener.

5. The method of claim 1, wherein the acoustic dampening material was provided in sheet form.

6. The method of claim 1, wherein the acoustic dampening material was applied to the dense, fiber-reinforced, structural cementitious panel of fiber-reinforced cement of the sound damping building panel through rolling, brushing, spraying or troweling.

7. The method of claim 1, wherein the acoustic dampening material is an adhesive including at least one of alkyl abietate, a plant resin and polyvinyl alcohol.

8. The method of claim 1, wherein the acoustic dampening material is an adhesive applied in a layer of 0.02 inch to 0.10 inch and including a polymer having a glass transition temperature (T_{g}) of −10° C. to about 30° C.

9. The method of claim 8, wherein the adhesive further includes plasticizer.

10. The method of claim 1, wherein the dense, fiber-reinforced, structural cementitious panel of fiber-reinforced cement of the sound damping building panel has a density of 55 pcf (1281 kg/m³) or greater.

11. The method of claim 1, wherein the dense, fiber-reinforced, structural cementitious panel of fiber-reinforced cement of the sound damping building panel has a density of 55-100 pcf (1281-1602 kg/m³).

12. The method of claim 1, wherein the existing building panel is a second dense, fiber-reinforced, structural cementitious panel of fiber-reinforced cement of the sound damping building panel having a density of 55 pcf (1281 kg/m³) or greater.

13. The method of claim 1, wherein the existing building panel is a second dense, fiber-reinforced, structural cementitious panel of fiber-reinforced cement of the sound damping building panel having a density of 55-100 pcf (1281-1602 kg/m³).

14. A sound damping building panel, comprising:
a single sheet of reinforced cement having a density of 55 pcf (881 kg/m³) or greater as a dense, fiber-reinforced, structural cementitious panel, the dense, fiber-reinforced, structural cementitious panel having opposed first and second outer surfaces;
a layer of acoustic dampening material, preferably viscoelastic acoustic dampening material, on the opposed first outer surface; and
a cover sheet, wherein the dampening material is located between the single sheet of reinforced cement and the cover sheet;
wherein the cover sheet has first and second sides, the cover sheet first side in contact with the layer of acoustic dampening material to contact and cover at least 80% of the area of the layer of acoustic dampening material.

15. The sound damping building panel of claim 14, wherein the fiber reinforced cement panel includes one of Portland cement based, Magnesium Oxide cement based and polymer cement based panels.

16. The sound damping building panel of claim 14, wherein the cover sheet is releasable from the dampening material.

17. The sound damping building panel of claim 15, wherein the cover sheet is releasable from the dampening material.
